(19) United States
(12) Patent Application Publication
(10) Pub. No.: US 2021/0269270 A1
(43) Pub. Date: Sep. 2, 2021

(54) CUTTING MACHINE

(71) Applicant: Horizon International Inc., Takashima-shi (JP)

(72) Inventors: Eiji AOKI, Takashima-shi (JP); Tomonori YACHI, Takashima-shi (JP); Hiromasa NAMBU, Takashima-shi (JP); Takehito YOKOGI, Takashima-shi (JP); Shinya KITAYAMA, Takashima-shi (JP)

(73) Assignee: Horizon International Inc., Takashima-shi (JP)

(21) Appl. No.: 17/182,329

(22) Filed: Feb. 23, 2021

(30) Foreign Application Priority Data
Feb. 28, 2020 (JP) 2020-032595

(51) Int. Cl. B65H 35/00; B65H 35/04; B65H 20/02

(52) U.S. Cl. CPC B65H 35/0086; B65H 20/02; B65H 35/04

(57) ABSTRACT

The cutting machine for cutting a paper, comprising: a conveying section configured to convey the paper one by one in a conveying direction; a rotating section configured to rotate the paper conveyed by the conveying section 2; and a downstream cutting section disposed on a downstream side of the rotating section in the conveying direction 1a, including at least one cutter, and configured to cut the paper rotated by the rotating section in the conveying direction 1a.

### CROSS-REFERENCE TO RELATED APPLICATIONS

This application is based on Japanese Patent Application No. 2020-032595, the contents of which are incorporated herein by reference in its entirety.

### BACKGROUND

### 1. Technical Field

The present disclosure relates to a cutting machine that cuts a standard paper having a predetermined size (for example, A4-size, letter size and so on) longitudinally and laterally so as to form a plurality of cut papers having a predetermined size (for example, postcard size, business card size and so on).

### 2. Description of Related Art

There is a cutting machine that cuts a standard paper having a predetermined size (for example, A4-size, letter size and so on) longitudinally and laterally so as to form a plurality of cut papers having a predetermined size (for example, postcard size, business card size and so on).

The cutting machine is described in Japanese Unexamined Patent Application Publication No. H10-76495 and so on.

The cutting machine comprises a first cutting section including a linear blade, and a second cutting section including a round blade. The cutting machine is configured to convey a standard paper from a conveying section one by one. The linear blade is extended perpendicular to a conveying direction and movable vertically. The round blade is rotatable in the conveying direction.

The cutting machine is configured to cut a conveyed paper perpendicular to the conveying direction by the first cutting section, then cut the conveyed paper in the conveying direction by the second cutting section.

The cutting machine must stop conveying the paper because the paper is cut by the vertical movement of the linear blade when cutting the paper perpendicular to the conveying direction by the first cutting section. Thus, there is a problem that the cutting machine cannot successively cut the paper and the cutting speed is slow.

It is an object of the present disclosure to provide a cutting machine that can successively cut a paper at a high speed.

### BRIEF SUMMARY

In order to achieve the object, the present disclosure provides a cutting machine for cutting a paper, comprising: a conveying section configured to convey the paper one by one in a conveying direction; a rotating section configured to rotate the paper conveyed by the conveying section; and a downstream cutting section disposed on a downstream side of the rotating section in the conveying direction, including at least one cutter, and configured to cut the paper rotated by the rotating section in the conveying direction.

According to a preferred embodiment of the present disclosure, the cutting machine further comprising: an upstream cutting section disposed on an upstream side of the rotating section in the conveying direction, including at least one cutter, and configured to cut the paper in the conveying direction so as to form a plurality of upstream cut papers; and a distance difference generating section disposed between the upstream cutting section and the rotating section, and configured to convey each of the upstream cut papers in the conveying direction so as to generate a distance difference between each of the upstream cut papers in the conveying direction.

According to a preferred embodiment of the present disclosure, the rotating section includes: an inner roller; and an outer roller disposed on an outer side than the inner roller with respect to a rotation center of the upstream cut paper, and configured to be rotated faster than a rotation speed of the inner roller.

According to a preferred embodiment of the present disclosure, the distance difference generating section includes: a constant speed roller configured to convey one of the upstream cut papers at a constant speed; and an acceleration roller configured to accelerate and convey the other of the upstream cut papers.

According to a preferred embodiment of the present disclosure, the distance difference generating section includes an acceleration reference sensor disposed on an upstream side of the acceleration roller, and configured to detect a position of the upstream cut paper so as to determine a timing of an acceleration of the acceleration roller.

According to a preferred embodiment of the present disclosure, the rotating section includes a rotation reference sensor configured to detect a position of each of the upstream cut paper so as to determine a timing of a rotation of the outer roller.

According to a preferred embodiment of the present disclosure, the cutting machine further comprises an aligning section configured to align each of the upstream cut papers rotated by the rotating section.

The cutting machine according to the present disclosure can successively cut a paper at a high speed.

### BRIEF DESCRIPTION OF THE DRAWING

FIG. 1 is a plan view showing a cutting machine according to the present application.

FIG. 2 is a plan view showing a distance difference generating section.

FIG. 3 is a timing chart showing a velocity of a constant speed roller and a timing of an acceleration of an accelerating roller.

FIG. 4 is a plan view showing a rotating section and an aligning section.

FIG. 5 is a timing chart showing a timing of an acceleration of an outer roller and a velocity of an inner roller.

FIG. 6 is a block diagram describing a control configuration of a controlling section.

### DETAILED DESCRIPTION

A cutting machine according to the present application will be explained below with reference to the drawings.

The cutting machine is configured to cut a paper 1 having a predetermined size longitudinally and laterally so as to form a plurality of cut papers having a predetermined size. The paper 1 before cut has, for example, a A4-size, a letter size and so on. The cut paper after cut has, for example, a postcard size, a business card size and so on. A plurality of drawing patterns is printed on the paper 1 before cut depending on the size of the paper after cut.

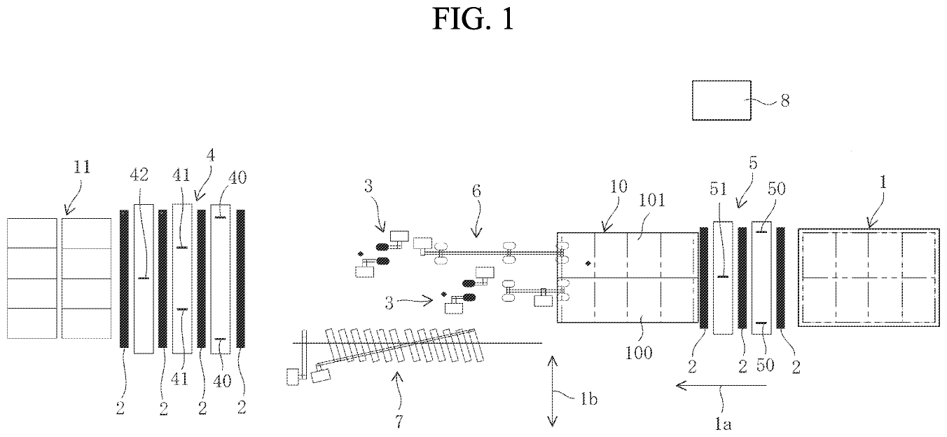

As shown in FIG. 1, the cutting machine comprises a conveying section 2 that conveys the paper 1 one by one in a conveying direction 1a. The conveying section 2 is extended in a direction 1b perpendicular to the conveying direction 1a. The conveying section 2 comprises a plurality of rollers that rotates in the conveying direction 1a. The rollers are arranged and spaced from each other in the conveying direction 1a. The paper 1 is conveyed on and through the rollers one by one.

The cutting machine comprises an upstream cutting section 5 that cuts (slits) the paper 1 in the conveying direction 1a. The upstream cutting section 5 comprises a pair of cutters 50 spaced from each other in the perpendicular direction 1b. Each of the cutters 50 is disposed adjacent to the opposite ends of the perpendicular direction 1b of the paper 1. The paper 1 has offset areas disposed adjacent to the opposite ends of the perpendicular direction 1b. The offset areas are cut from the paper 1 by each of the cutters 50.

The upstream cutting section 5 comprises a cutter 51 disposed on the downstream side of the conveying direction 1a of the pair of cutters 50. The cutter 51 is disposed adjacent to the center of the paper 1 in the perpendicular direction 1b. The cutter 51 is configured to cut (slit) the paper 1 adjacent to its center of the perpendicular direction 1b so as to form two divided upstream cut papers 10 (100, 101).

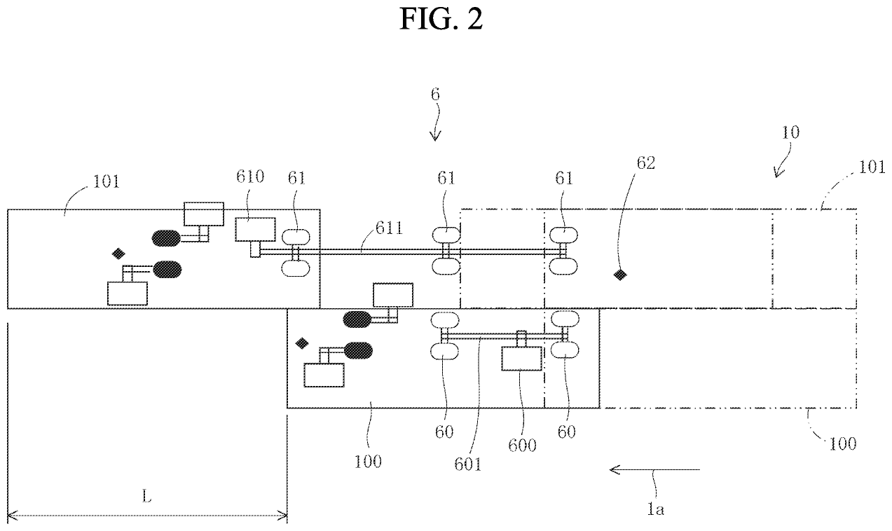

As shown in FIG. 1, the cutting machine comprises a distance difference generating section 6 disposed on the downstream side of the upstream cutting section 5. As shown in FIG. 2, the distance difference generating section 6 is configured to generate a distance difference L between each of the upstream cut papers 100, 101 in the conveying direction 1a.

The distance difference generating section 6 comprises a plurality of constant speed rollers 60 that conveys the upstream cut paper 100 in the conveying direction 1a at a constant speed. The distance difference generating section 6 comprises a plurality of accelerating rollers 61 that accelerates, decelerates and conveys the upstream cut paper 101 in the conveying direction 1a.

The constant speed rollers 60 are spaced from each other in the conveying direction 1a and connected with each other by a timing belt 601. The timing belt 601 is rotated at a constant speed by a driving section 600 so that the constant speed rollers 60 rotate at a constant speed in the conveying direction 1a.

The accelerating rollers 61 are spaced from each other in the conveying direction 1a and connected with each other by a timing belt 611. The timing belt 611 is accelerated and decelerated by a driving section 610 so that the accelerating rollers 61 rotate in the conveying direction 1a at accelerated and decelerated paces.

The distance difference generating section 6 further comprises an acceleration reference sensor 62 disposed on an upstream side of the accelerating rollers 61. The acceleration reference sensor 62 is configured to detect the front edge of the upstream cut paper 101 to be conveyed. The timings of the acceleration and deceleration of the accelerating rollers 61 are determined based on the detected result of the acceleration reference sensor 62.

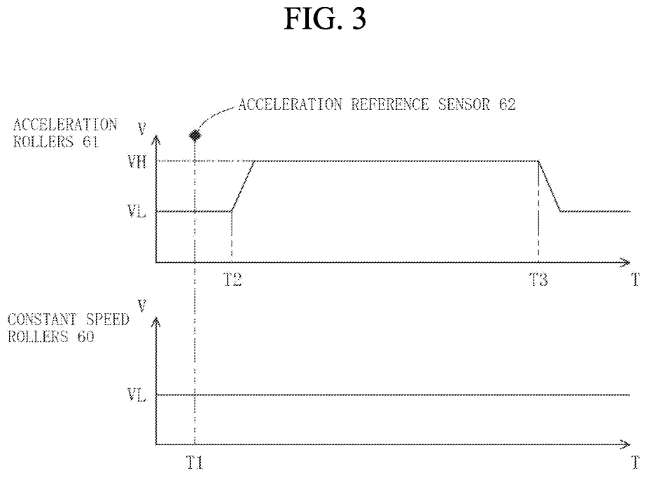

At first, as shown in FIG. 3, the constant speed rollers 60 and the accelerating rollers 61 are rotated at a speed VL. Then, the acceleration reference sensor 62 detects the front edge of the upstream cut paper 101 at a time T1, and the accelerating rollers 61 start to accelerate so as to rotate at a speed VH (VH>VL) at a time T2 after a predetermined time from the time T1. And then, the accelerating rollers 61 start to decelerate so as to rotate at an original speed VL at a time T3.

Thus, the upstream cut paper 101 is conveyed at the speed VL, then it is conveyed at the speed VH (VH>VL) for a predetermined period, and then it is conveyed at the speed VL. During the period, the upstream cut paper 100 is conveyed at the speed VL. As a result, the upstream cut paper 101 overtakes the upstream cut paper 100 so as to generate a distance difference L between the upstream cut papers 100, 101 in the conveying direction 1a.

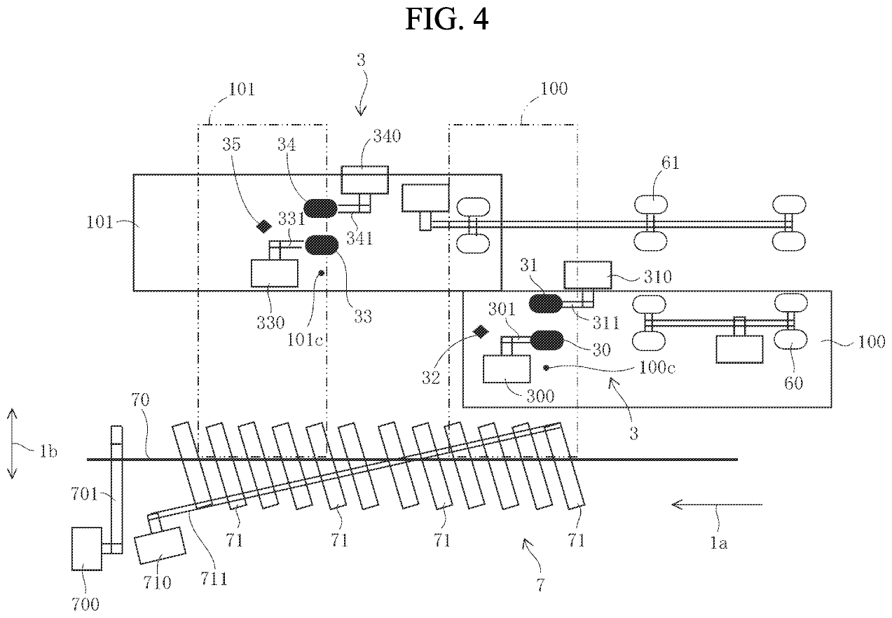

As shown in FIG. 1, the cutting machine comprises a rotating section 3 disposed on a downstream side of the distance difference generating section 6. As shown in FIG. 4, the rotating section 3 comprises an inner roller 30 and an outer roller 31 that rotate the upstream cut paper 100. The rotating section 3 further comprises an inner roller 33 and an outer roller 34 that rotate the upstream cut paper 101.

Each of the pairs of the inner rollers 30, 33 and the outer rollers 31, 34 are disposed corresponding to each of the upstream cut papers 100, 101. Each of the pairs of the inner rollers 30, 33 and the outer rollers 31,34 are disposed in the perpendicular direction 1b. The pair of the inner roller 33 and the outer roller 34 is disposed on the downstream side of the pair of the inner roller 30 and the outer roller 31.

As shown in FIG. 4, the inner rollers 30, 33 are disposed on the inner sides than the outer rollers 31, 34 with respect to the rotation centers 100C, 101C of the upstream cut papers 100, 101. The outer rollers 31, 33 are disposed on the outer sides than the inner rollers 30, 33 with respect to the rotation centers 100C, 101C of the upstream cut papers 100, 101.

The inner rollers 30, 33 are connected with driving sections 300, 330 via timing belts 301, 331. The inner rollers 30, 33 rotate at a constant speed in the conveying direction 1a. The outer rollers 31, 34 are connected with driving sections 310, 340 via timing belts 311, 341. The outer rollers 31, 34 rotate in the conveying direction 1a at accelerated and decelerated paces.

As shown in FIG. 4, the rotating section 3 comprises a rotation reference sensor 32 disposed on the downstream sides of the constant speed rollers 60. The rotating section 3 further comprises a rotation reference sensor 35 disposed on the downstream sides of the acceleration rollers 61. The rotation reference sensors 32, 35 are configured to detect the front edges of the upstream cut papers 100, 101 to be conveyed. The timings of the acceleration and deceleration of the outer rollers 31, 34 are determined based on the detected results of the rotation reference sensors 32, 35.

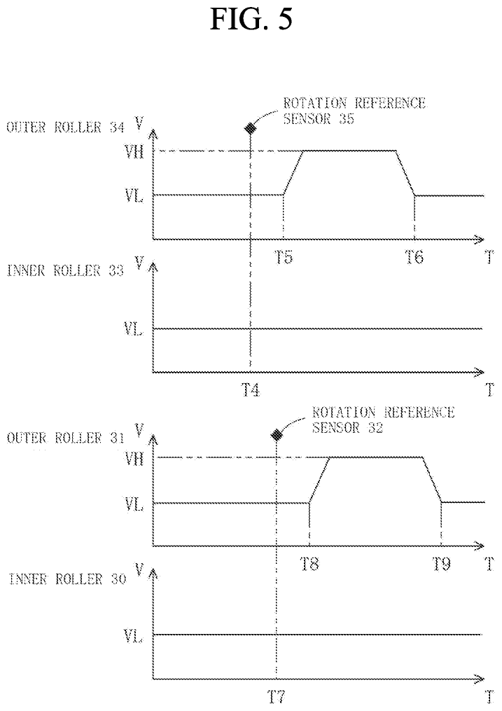

At first, as shown in FIG. 5, each of the inner rollers 30, 33 and the outer rollers 31, 34 rotate at the speed VL. Then, the rotation reference sensor 35 detects the front edge of the upstream cut paper 101 at a time T4, and then the outer roller 34 starts to accelerate at a speed VH (VH>VL) at a time T5 after a predetermined time from the time T4.

The rotation reference sensor 32 detects the front edge of the upstream cut paper 100 at a time T7 after a predetermined time from the time T4, then the outer roller 31 starts to accelerate at a speed VH (VH>VL) at a time T8 after a predetermined time from the time T7.

Thus, a speed difference between the speed VL of the inner rollers 30, 33 and the speed VH of the outer rollers 31, 34 makes the upstream cut papers 100, 101 rotate around the rotation centers 100C, 101C.

Then, the outer roller 34 starts to decelerate so as to rotate at the original speed VL at a time T6 after a predetermined time from the time T5. The outer roller 31 starts to decelerate so as to rotate at the original speed VL at a time T9 after a predetermined time from the time T8.

As shown in FIG. 1, the cutting machine further comprises an aligning section 7 that align each of the upstream cut papers 100, 101 rotated by the rotating section 3 on the one end of the cutting machine in the perpendicular direction 1b. As shown in FIG. 4, the aligning section 7 comprises a reference plate 70 extended in the conveying direction 1a. The reference plate 70 is connected with a driving section 700 via a timing belt 701. The reference plate 70 is moved and disposed on a predetermined position in the perpendicular direction 1b by the rotation of the driving section 700.

The aligning section 7 comprises a plurality of aligning rollers 71 inclined at a predetermined degree angle to the conveying direction 1a and disposed across the reference plate 70. Each of the aligning rollers 71 are spaced from and connected with each other via a timing belt 711. The timing belt 711 rotates at a constant speed by a driving section 710 so that the aligning rollers 71 rotate at a constant speed.

Thus, the upstream cut papers 100, 101 rotated by the rotating section 3 are conveyed on the aligning rollers 71 in the conveying and perpendicular directions 1a, 1b so that the one end of each of the upstream cut papers 100, 101 is abutted against the reference plate 70. Thus, the upstream cut papers 100, 101 are rotated at right angle. The rotating section 3 rotate the upstream cut papers 100, 101 in the counterclockwise direction.

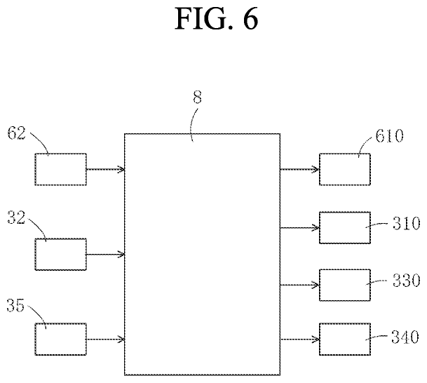

As shown in FIG. 1, the cutting machine further comprises a controlling section 8 that memorizes a predetermined program. As shown in FIG. 6, the controlling section 8 determines the timings of the acceleration and deceleration of the driving sections 610, 310, 330, 340 based on the detecting signal from the acceleration reference sensor 62 and the rotation reference sensors 32, 35.

As above described, the distance difference L between the upstream cut papers 100, 101 is generated in the conveying direction 1a. Thus, each of the upstream cut papers 100, 101 can rotate without colliding against each other.

The rotation of the fore upstream cut paper 101 is completed earlier than or at the same time when the rotation of the rear upstream cut paper 100 is completed. Thus, the cutting machine can convey upstream cut papers 100, 101 successively at a high speed. Specifically, if the rotation of the rear upstream cut paper 100 is completed earlier than when the rotation of the fore upstream cut paper 101 is completed, the rear upstream cut paper 100 cannot be conveyed until the rotation of the fore upstream cut paper 101 is completed. Thus, in this case, the cutting machine cannot convey the upstream cut papers 100, 101 successively.

As shown in FIG. 1, the cutting machine further comprises a downstream cutting section 4 disposed on the downstream side of the rotating section 3. The downstream cutting section 4 is configured to cut (slit) the upstream cut papers 100, 101 rotated by the rotating section 3 in the conveying direction 1a.

The downstream cutting section 4 comprises a pair of cutters 40 spaced from each other in the perpendicular direction 1b. Each of the cutters 40 is disposed adjacent to the opposite ends of the perpendicular direction 1b of the upstream cut papers 100, 101. Each of the upstream cut papers 100, 101 has an offset area adjacent to the opposite ends of the perpendicular direction 1b so that the offset areas are cut from the paper 1.

The downstream cutting section 4 further comprises a pair of cutters 41 disposed on the downstream side of the pair of the cutters 40 in the conveying direction 1a, and a cutter 42 disposed on the downstream side of the cutters 41 in the conveying direction 1a. The cutter 42 is disposed adjacent to the centers of the upstream cut papers 100, 101 in the perpendicular direction 1b. Each of the cutters 41 is disposed on the center between each of the cutters 40 and the cutter 42.

Each of the cutters 41, 42 is configured to slit the upstream cut papers 100, 101 at three lines in the conveying direction 1a so as to form eight of the divided downstream cut papers 11.

As described above, embodiments of the present disclosure are explained. However, the constructions of the present implementation are not limited to the embodiments.

The constructions of the present implementation may be changed and modified as follows.
The cutting machine may not comprise the upstream cutting section 5.
The upstream cutting section 5 may comprise only the cutters 50 and may not comprise the cutter 51.
The upstream cutting section 5 may comprise more than two cutters 51. In this case, the distance difference generating section 6 and the rotating section 3 are provided corresponding to the number of the upstream cut papers.

What is claimed is:

1. A cutting machine for cutting a paper, comprising:
a conveying section configured to convey the paper one by one in a conveying direction;
a rotating section configured to rotate the paper conveyed by the conveying section; and
a downstream cutting section disposed on a downstream side of the rotating section in the conveying direction, including at least one cutter, and configured to cut the paper rotated by the rotating section in the conveying direction.

2. A cutting machine according to claim 1 further comprising:
an upstream cutting section disposed on an upstream side of the rotating section in the conveying direction, including at least one cutter, and configured to cut the paper in the conveying direction so as to form a plurality of upstream cut papers; and
a distance difference generating section disposed between the upstream cutting section and the rotating section, and configured to convey each of the upstream cut papers in the conveying direction so as to generate a distance difference between each of the upstream cut papers in the conveying direction.

3. A cutting machine according to claim 1 wherein
the rotating section includes:
an inner roller; and
an outer roller disposed on an outer side than the inner roller with respect to a rotation center of the upstream cut paper, and configured to be rotated faster than a rotation speed of the inner roller.

4. A cutting machine according to claim 2 wherein
the distance difference generating section includes:
a constant speed roller configured to convey one of the upstream cut papers at a constant speed; and
an acceleration roller configured to accelerate and convey the other of the upstream cut papers.

5. A cutting machine according to claim 4 wherein
the distance difference generating section includes an acceleration reference sensor disposed on an upstream side of the acceleration roller, and configured to detect a position of the upstream cut paper so as to determine a timing of an acceleration of the acceleration roller.

6. A cutting machine according to claim 3 wherein
the rotating section includes a rotation reference sensor configured to detect a position of each of the upstream cut paper so as to determine a timing of a rotation of the outer roller.

7. A cutting machine according to claim 1 further comprises an aligning section configured to align each of the upstream cut papers rotated by the rotating section.
